(19) United States
(12) Patent Application Publication
(10) Pub. No.: US 2015/0328701 A1
(43) Pub. Date: Nov. 19, 2015

(54) Saw Tool for a Machine Tool

(71) Applicant: Robert Bosch GmbH, Stuttgart (DE)

(72) Inventors: Marcel Kauz, Zuchwil, Schweiz (CH); Martin Kocher, Solothurn/Schweiz (CH)

(21) Appl. No.: 14/388,753

(22) PCT Filed: Feb. 14, 2013
(86) PCT No.: PCT/EP2013/052933

§ 371 Date: Sep. 26, 2014

(30) Foreign Application Priority Data
Mar. 29, 2012 (DE) 10 2012 205 041.8

(51) Int. Cl. B23D 61/12; B23B 51/04

(52) U.S. Cl. CPC B23D 61/121; B23B 51/0406; B23D 61/123; B23B 2251/04; B23B 2251/14; B23B 2251/28; B23B 2251/46

(57) ABSTRACT

A saw tool comprises a sequence of saw teeth on a working side of the saw tool. A chip space is defined between each two successive saw teeth of the sequence of saw teeth. Each chip space defines a corresponding length and height. Each length is at least twice as great as the corresponding height

The invention relates to a saw tool for a power tool according to the preamble of claim 1.

### PRIOR ART

Known from DE 200 02 593 U1 is a saw blade for a compass saw or saber saw, having a rectilinear carrier blade that has a row of saw teeth on the working side. Such saw blades may be used for performing work on workpieces of differing materials, wherein, depending on the intended application, in particular in dependence on various workpiece materials, saw blades having an adapted tooth geometry and tooth material are used. For example, the saw teeth of a saw blade designed for performing work on wood have a relatively deep chip space between successive saw teeth and, moreover, the rake angle is positive, which is associated with lesser feed forces. Owing to a relatively large relief angle, however, the risk of tooth breakage is increased.

Such saw blades cannot be used for sawing fiber reinforced plastics, since the fibers have a highly abrasive effect, resulting in rapid wear of the saw teeth. Furthermore, it must be taken into consideration that, in sawing, fibers must not tear out and there must not be excessively high cutting forces upon the saw teeth and the material layers of the workpiece being worked.

### DISCLOSURE OF THE INVENTION

The invention is based on the object of designing a saw tool for a power tool by use of simple expedients, such that even materials that are highly abrasive in their effect can be worked with a good pattern of cut with, at the same time, reduced risk of wear.

This object is achieved according to the invention by the features of claim 1. The dependent claims specify expedient developments.

The saw tool according to the invention is used in power tools, in particular in hand-guided power tools, which preferably have an electric motor as a drive. On a working side the saw tool has cutting or saw teeth, disposed between each of which there is a chip space for the removal of sawing chips or sawdust. The saw tool is preferably a saw blade, in particular for a compass saw or saber saw, wherein, in principle, realization of the saw tool as a cylindrical drilling body for use in a hole saw is also possible.

The saw tool according to the invention has a chip space between two successive saw teeth, the chip geometry of which is realized such that the length of the chip space—as viewed in the direction of the successive saw teeth along the longitudinal direction of the working side—is at least twice as great as the height of the chip space that is measured orthogonally in relation to the length of the chip space. The ratio of length to height of the chip space is preferably at least 2.1, in particular at least 2.5. This geometry gives a chip space having a significantly greater length than height, such that the chip space as a whole has an elongated shape with relatively little height. A saw tooth having such a chip space is suitable, in particular, for performing work on a workpiece of fiber reinforced plastic, which is composed of fibers and a binder, for example resins such as epoxy resin or phenol resin, wherein, if appropriate, thermoplastics, for example polyamide or polypropylene, may also be used as a binder. E-glass, carbon, polyethylene or aramid, for example, are used as fibers. The fibers in this case may be laid individually or in the manner of a textile mat in the binder.

Such materials have a highly abrasive effect, with the result that a saw tool used for performing work on the material is in principle subject to increased wear. At the same time, however, when such materials are worked there is no chip formation, or only slight chip formation; instead, fine particles are produced, such that the chip space does not have to serve to form and break chips, as in the case of wood working, for example, but merely to receive and remove the particles produced.

Furthermore, it is advantageous that the rake angle, which denotes the angle between the tooth face of a saw tooth and the vertical in relation to the longitudinal axis of the working side, lies in an angular range of between −5° and 3°, and preferably is −3°. This rake angle, in particular in combination with the relatively long chip space, reduces the cutting force per saw tooth, thereby also reducing the risk of delamination, in which different layers of the workpiece material become detached from each other. The risk of fibers of the workpiece being torn out is also reduced. Furthermore, the wear on the saw tool is reduced. The wear can be reduced yet further in that the saw teeth are composed of hard metal. It may be expedient in this case for the saw tool to be composed of a carrier blade and a tooth strip that is connected to the carrier blade and comprises saw teeth, wherein the tooth strip, including the saw teeth disposed thereon, is made of hard metal, whereas the carrier blade need not necessarily be composed of hard metal. Both hard metal and other materials are possibilities for the carrier blade.

According to yet another expedient embodiment, the relief angle, which denotes the angle between the tooth back of a saw tooth and the longitudinal axis of the working side, lies in an angular range of between 20° and 50°, in particular is 30°.

According to yet another expedient embodiment, the lateral tooth angle, which defines the angular position of the saw tooth in relation to the tooth strip, wherein an angular position of 90° corresponds to a rectilinear alignment of the saw teeth, lies in an angular range of less than 90°, for example is 75°.

Furthermore, it is possible—in particular with the additional provision of a so-called staggered setting—for the tips of the saw teeth to be located on a tooth row that does not lie along one straight line, but on two lines that are oblique in relation to each other. In this case, in particular if the staggered setting is provided, it must be ensured that the tooth gullets lie within the tooth strip (for example, hard metal strip). In this case, the lines that are oblique in relation to each other ideally form an angle of approximately 0.5° and approximately 1°, but at least of 0.25° to 0.75° and 0.75° to 1.25°, with the longitudinal axis of the working side.

According to another expedient embodiment, it is provided that the roughness of the saw teeth is at least 1.6.

Further advantages and expedient embodiments are given by the description of the figures and the drawings, wherein:

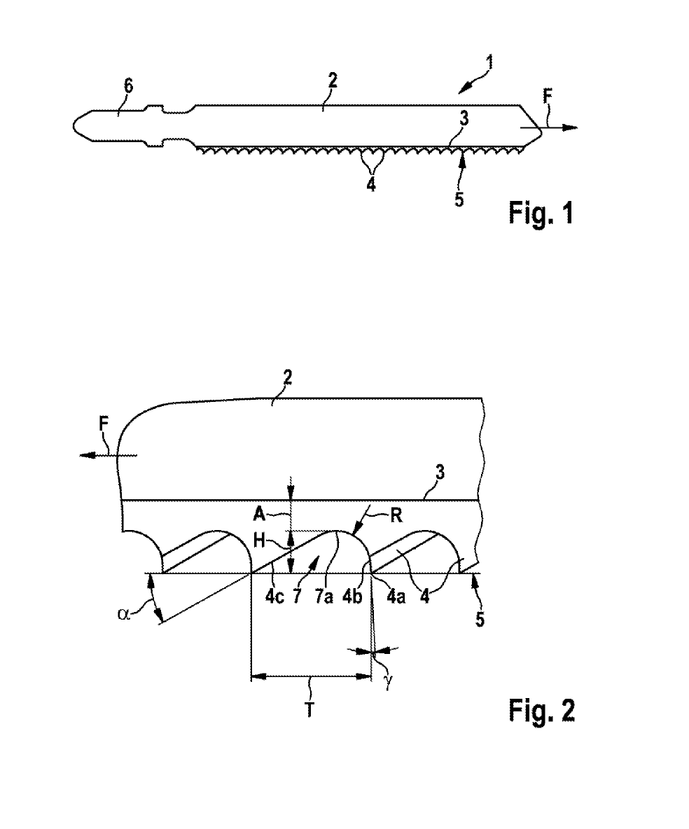

FIG. 1 shows a side view of a saw blade for a compass saw, or saber saw,

FIG. 2 shows an enlarged representation of the working side, or cutting edge, with the saw teeth,

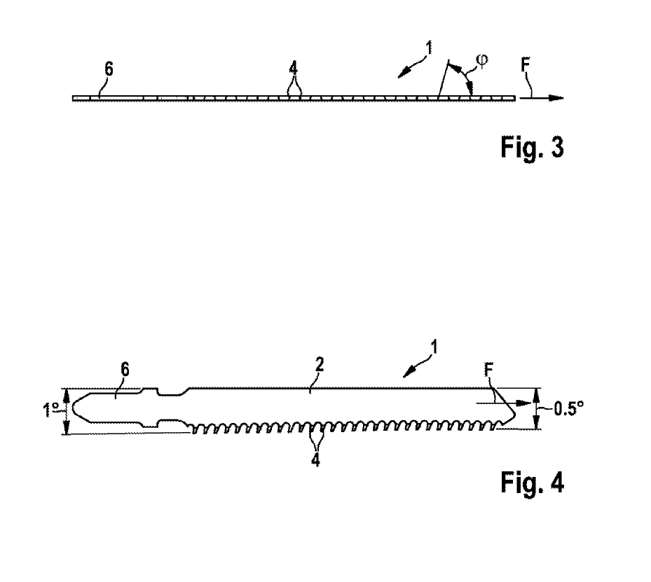

FIG. 3 shows a view from beneath the saw blade,

FIG. 4 shows another realization of a saw blade.

In the figures, components that are the same are denoted by the same references.

A saw blade 1 for a compass saw, or saber saw, is represented in FIG. 1. The saw blade 1 has a carrier blade 2, which is provided with a tooth strip, or a tooth band 3, on the working side 5 of which saw teeth 4 are disposed in a row. Realized integrally with the carrier blade 2 is a shank 6, which is opposite the tip of the saw blade and via which fastening to a power tool, in particular a hand power tool, is effected.

The forward working direction is indicated by the arrow F. The working direction is parallel to the longitudinal axis of the working side 6 along which the saw teeth 4 are disposed.

The tooth strip 3, with the saw teeth 4, is preferably composed of hard metal. In principle, the material of the tooth strip 3 may differ from the material of the carrier blade 2. If appropriate, however, the carrier blade 2 and the tooth strip 3 may be made of the same material.

As can be seen from the enlarged representation according to FIG. 2, the length T of the chip space 7 between successive saw teeth 4—as viewed in the direction of the longitudinal axis of the working side 5—is at least twice as great as the height H between the working side, which extends through the tooth tips 4a, and the chip space base 7a of the chip space 7. According to a preferred embodiment, the ratio of the length T to the height H of the chip space 7 is at least 2.1, preferably at least 2.5. The chip space base 7a, realized in the form of a circle sector having the radius R, is at the same time located at a distance in relation to the transition from the tooth strip 3 to the carrier blade 2, this distance being denoted by the reference A. The rake angle γ lies in an angular range of between −5° and 3°, and is preferably −3°. The rake angle γ denotes the angle between an orthogonal to the longitudinal axis of the working side 5 and the tooth face 4b of the saw teeth.

The relief angle α between the longitudinal axis of the working side 5 and the tooth backs 4c of the saw teeth 4 lies in an angular range of between 20° and 50°, and is preferably 30°.

As can be seen from FIG. 3, the lateral tooth angle φ lies in a value range of less than 90°, for example is 75°.

As represented in the exemplary embodiment according to FIG. 4, the saw teeth 4 may be disposed along two lines, aligned at an angle in relation to each other, on the same working side, wherein the lines form an angle of 0.5° in the front region of the saw blade, and an angle of 1° in the rear region of the saw blade, with the working direction F, or with the back side of the carrier blade 2 running parallel thereto. The lines intersect, for example, in the axial center of the row of saw teeth.

1. A saw tool for a power tool, comprising:
a sequence of saw teeth on a working side of the saw tool,
wherein a chip space is defined between each two successive saw teeth of the sequence of saw teeth;
wherein each chip space defines a corresponding length and height; and
wherein the length of each chip space is at least twice as great as the corresponding height.

2. The saw tool as claimed in claim 1, characterized in that wherein a ratio of length to height of each chip space is at least 2.1.

3. The saw tool as claimed in claim 1, wherein a rake angle of the saw teeth is between −5° and 3°.

4. The saw tool as claimed in claim 3, wherein the rake angle is −3°.

5. The saw tool as claimed in claim 1, wherein a relief angle of the saw teeth is between 20° and 50°.

6. The saw tool as claimed in claim 5, wherein the relief angle is 30°.

7. The saw tool as claimed in claim 1, wherein a lateral tooth angle of the saw teeth is less than 90°.

8. The saw tool as claimed in claim 7, wherein the lateral tooth angle is 75°.

9. The saw tool as claimed in claim 1, wherein a roughness of the saw teeth is at least 1.6.

10. The saw tool as claimed in claim 1, further comprising:
a carrier blade; and
a tooth strip connected to the carrier blade.

11. The saw tool as claimed in claim 10, wherein the tooth strip formed of a hard metal.

12. The saw tool as claimed in claim 1, wherein the saw tool is a saw blade.

13. The saw tool as claimed in claim 1, wherein the saw tool is a cylindrical drilling body for a hole saw.

14. A power tool, comprising:
a saw tool including a sequence of saw teeth on a working side of the saw tool,
wherein a chip space is defined between each two successive saw teeth of the sequence of saw teeth;
wherein each chip space defines a corresponding length and height; and
wherein the length of each chip space is at least twice as great as the corresponding height.

15. The saw tool as claimed in claim 1, wherein a ratio of length to height of each chip space is at least 2.3.

16. The saw tool as claimed in claim 1, wherein a ratio of length to height of each chip space is at least 2.5.

17. The saw tool as claimed in claim 1, wherein a relief angle of the saw teeth is less than or equal to 35°.
